(19) United States
(12) Patent Application Publication
(10) Pub. No.: US 2009/0128113 A1
(43) Pub. Date: May 21, 2009

(54) POWER CONVERTER HAVING AUTO CONVERSION FUNCTION FOR PULSE SKIP MODE AND CONTROL METHOD

(75) Inventor: Ji-Yeoul RYOO, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/270,078

(22) Filed: Nov. 13, 2008

(30) Foreign Application Priority Data
Nov. 15, 2007 (KR) 10-2007-0116688

(51) Int. Cl. G05F 1/618

(52) U.S. Cl. 323/283

(57) ABSTRACT

A power converter having an auto conversion function for a pulse skip mode (PSM) and a related control method are provided. The power converter having an auto conversion function for a PSM and a control method thereof can provide a PSM capable of preventing unnecessary switching operations and, thus, improving the efficiency of the power converter by automatically switching to the PSM even when a load is small.

### CROSS-REFERENCE TO RELATED APPLICATION

This application claims the benefit of Korean Patent Application No. 10-2007-0116688, filed Nov. 15, 2007, the subject matter of which is hereby incorporated by reference.

### BACKGROUND

The invention relates to a power converter having an auto conversion function for a pulse skip mode, and a related control method.

Many electronic devices commonly use one or more batteries (hereafter, singularly or collectively “battery”) as a primary or back-up power supply. This is particularly true of portable electronic devices. Unfortunately, the output voltage level provided by a battery-based power system tends to sag as the battery is discharged with use. This undesirable result may be mitigated by the use within an electronic device of a power converter. The power converter essentially converts a provided battery output voltage into a defined (e.g., a specified) voltage, thereby ensuring that the internal circuitry of the electronic device receives adequate power. The power converter may be used as a charging circuit for charging a battery with external power applied from an outside source.

In many aspects, the power converter may be seen as a direct current (DC) to DC converter. The conversion efficiency of the power converter significantly affects the length of time that the electronic device can run on the battery. Since the electrical current required by an electronic device will vary with its operating mode, the power converter should exhibit high conversion efficiency regardless of device current demands (or load variations).

Many conventional power converters are configured to cope with load variations (i.e., variation in power consumption by internal circuitry) using a technique referred to as pulse width modulation (PWM). The PWM power converter senses the magnitude of a load and controls the width of a pulse signal controlling a switch that supplies current to the internal circuitry load in accordance with the sensed load magnitude. Since the switch may be turned ON/OFF to supply voltage or current in response to the load magnitude, relatively high efficiency may be provided even under variable load conditions.

When a relatively large load is sensed by a PWM power converter, the power loss due to pulse signal switching will be relatively small in relation to a continuously (or near continuously) provided output power. Thus, the conventional power converter is quite efficient in meeting the demands of large loads. But the high-efficiency provision of continuous (or near continuous) power significantly shortens the battery life of an electronic device, and extending battery life is a critical design goal for many portable electronic devices. Thus, as reduced power levels are switched through the conventional PWM power converter, the associated switching power loss ratio will increase in relation to the reduced output power. That is, more frequent switching operations in relation to reduced loads and corresponding reduced power output causes the overall efficiency of the PWM power converter to decrease. In order to avoid this outcome, the number of switching operations performed by a power converter should be reduced to maintain high efficiency even under reduced load conditions.

### SUMMARY

Embodiments of the invention provide a power converter having an auto conversion function for a pulse skip mode (PSM) useful when the load placed on the power converter is relatively small. Embodiments of the invention also provide a control method of such a power converter.

In one embodiment, the invention provides a power converter comprising; an output unit connected between a power supply voltage, a ground voltage, and an output node, and configured to apply the power supply voltage or ground voltage to a first node in response to first and second switching signals, and further configured to provide an output voltage to the output node by smoothing the voltage apparent at the first node, and a controller comparing a sensing signal generated at a predetermined level indicating a low load state and in response to a ramp signal and a current sensing signal, wherein the current sensing signal corresponds to current flowing to the first node in accordance with the magnitude of a load connected to the output node as indicated by a feedback signal, the controller being configured to operate in a normal mode to generate a pulse width modulation signal activating the first and second switching signals when a level of the feedback signal is higher than the predetermined level, and being further configured to operate in a pulse skip mode to generate the pulse width modulation signal deactivating the first and second switching signals when the load is small and the level of the feedback signal falls below the predetermined level.

In another embodiment, the invention provides a control method for a power converter having an output unit connected between a power supply voltage, a ground voltage, and an output node, and configured to apply the power supply voltage or ground voltage to a first node in response to first and second switching signals and output an output voltage to the output node by smoothing a voltage level variation of the first node, the method comprising; generating a ramp signal and a current sensing signal corresponding to a current flowing from the power supply voltage to the first node, and generating a sensing signal having or exceeding a control level for setting a low load state in response to the ramp signal and the current sensing signal, generating a feedback signal having a voltage level corresponding to a load of an internal circuit connected to the output node, operating in a normal mode to generate a pulse width modulation signal for activating the first and second switching signals by comparing the feedback signal with the sensing signal when a level of the feedback signal is higher than the control level, and automatically switching to a pulse skip mode by generating the pulse width modulation signal for deactivating the first and second switching signals when the load is small and the level of the feedback signal is lower than the control level, and generating the first and second switching signals for controlling first and second switch transistors in response to the pulse width modulation signal.

### BRIEF DESCRIPTION OF THE DRAWINGS

FIG. 1 is a circuit diagram illustrating a power converter according to an embodiment of the invention; and

FIG. 2 is a related timing diagram illustrating the operation of the power converter of FIG. 1.

### DESCRIPTION OF EMBODIMENTS

Embodiments of the invention will now be described in some additional detail with reference to the accompanying drawings. The invention may, however, be embodied in many different forms and should not be construed as being limited to only the illustrated embodiments.

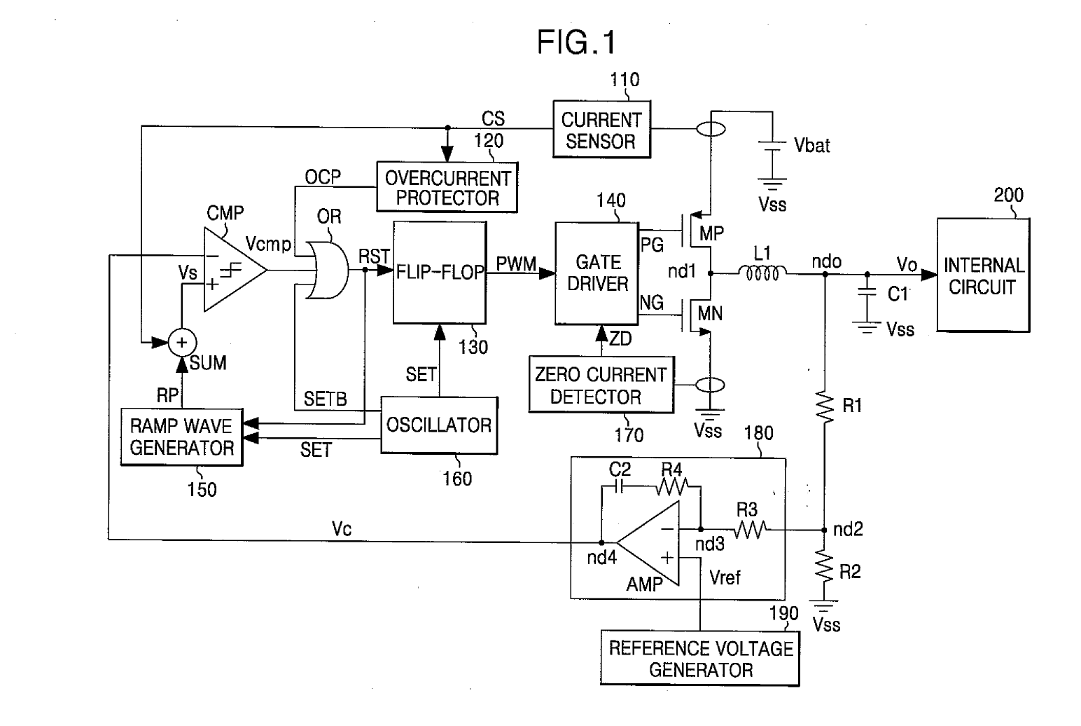

FIG. (FIG.) 1 is a circuit diagram illustrating a power converter according to an embodiment of the invention. The power converter of FIG. 1 receives a power supply voltage Vbat, converts the power supply voltage Vbat into a constant output voltage Vo adapted for use by an internal circuit 200.

In FIG. 1, the power converter generally comprises a power supply source, indicated as providing power supply voltage Vbat and comprising a battery or external voltage source, two transistors MP and MN, an inductor L1, a first capacitor C1, and a controller controlling the switch operation of the two transistors MP and MN. The power supply source provides a DC input voltage to the power converter which is subsequently converted into the output voltage Vo and supplied to internal circuit 200.

The PMOS transistor MP connected between the power supply voltage Vbat and a first node nd1 receives a first switching signal PG through its gate terminal. The PMOS transistor MP is a switch transistor supplying the first node nd1 with the power supply voltage Vbat for operating the internal circuit 200 in response to the first switching signal PG. The NMOS transistor MN connected between the first node nd1 and ground voltage source Vss (or “ground”) receives a second switching signal NG through its gate terminal. The NMOS transistor MN is a switch transistor discharging the electrical charge accumulated on inductor L1 in response to the second switching signal NG.

A low pass filter is essentially formed by inductor L1 connected between the first node nd1 and an output node ndo, and the first capacitor C1 connected between the output node ndo and ground Vss. That is, the output voltage Vo is output through a low pass filter circuit that smoothes any high frequency component associated with the power supply voltage Vbat.

In response to the output voltage Vo, the controller outputs the switching signals PG and NG that control the two switch transistors MP and MN.

A current sensor 110 outputs a current sensing signal CS upon sensing a current flowing from the power supply voltage Vbat to the first node nd1. In one embodiment, the current sensing signal CS may be constantly maintained at a level that varies with the current flowing to the first node nd1. When the current sensing signal CS rises above a predetermined threshold level, an over-current protector 120 generates an over-current sensing pulse OCP.

An oscillator 160 generates a set signal SET and an inverted set signal SETB having a defined duty cycle. A ramp wave generator 150 generates a ramp signal RP having a ramp waveform in response to the rising edge of the set signal SET and resets in response to the rising edge of a reset signal RST output from an OR gate. Like the current sensing signal CS, the ramp signal RP may be maintained at a level that varies with the ramp waveform in response to the set signal SET, and transition back to an initial level in response to the reset signal RST. An adder (SUM) provides a sensing signal Vs by adding the current sensing signal CS received from current sensor 110 to the ramp signal RP received from ramp wave generator 150.

First and second resistors R1 and R2 connected between the output node ndo and ground form a voltage-dividing circuit. The voltage applied to the output node ndo is divided by a ratio of the resistance values for the first and second resistors R1 and R2 before being applied to a second node nd2. An error amplifier 180 generates a feedback signal Vc by amplifying a voltage difference between the voltage apparent at the second node nd2 and a reference voltage Vref provided by reference voltage generator 190. A fourth resistor R4 and a second capacitor C2 connected in series between a third node nd3 and a fourth node nd4 form a feedback circuit to prevent unstable oscillation of a differential amplifier (AMP). An amplification ratio for the amplifier (AMP) may be controlled by a ratio of the impedance of the fourth resistor R4 and the second capacitor C2 of the feedback circuit to the impedance of the third resistor R3.

A comparator (CMP) provides a comparison signal Vcmp by comparing the sensing signal Vs received from the adder (SUM) with the feedback signal Vc received from the error amplifier 180. In the illustrated embodiment, it is assumed that the comparison signal Vcmp is generated with a high logic level when the voltage level of the feedback signal Vc is lower than that of the sensing signal Vs, and is generated at a low logic level when the voltage level of the feedback signal Vc is higher than that of the sensing signal Vs. The OR gate outputs the reset signal RST by performing a logical-OR operation on the over-current sensing pulse OCP, the inverted set signal SETB, and the comparison signal Vcmp.

A flip-flop 130, which is an RST-priority-edge-triggered flip-flop, provides a high-level PWM signal synchronously with the rising edge of the set signal SET, and a low-level PWM signal synchronously with the rising edge of the reset signal RST. However, since flip-flop 130 may be the RST-priority-edge-triggered flip-flop, it may not operate at the rising edge of the set signal SET while the reset signal RST is maintained at the high level. That is, a PWM signal output may be maintained at the low level while the reset signal RST is maintained at the high level.

A zero current detector 170 detects the current flowing from the NMOS transistor MN to ground voltage Vss in order to prevent a reverse current from flowing to the inductor L1. When the current flowing from the NMOS transistor MN to the ground voltage Vss is 0, zero current detector 170 generates a zero current detection signal ZD and provides it to a gate driver 140.

Gate driver 140 applies the first switching signal PG to the gate terminal of the PMOS transistor MP in response to the PWM signal, and the second switching signal NG to the gate terminal of the NMOS transistor MN. Since the first switching signal PG is generated in response to only the PWM signal and the second switching signal NG is generated in response to the PWM signal and the zero current detection signal ZD, the two switching signals PG and NG may be individually output.

Since the current sensing signal CS and the ramp signal RP can be constantly maintained at a predetermined level, the power converter of FIG. 1 may correspondingly maintain the sensing signal Vs, which is the sum of the current sensing signal CS and the ramp signal RP, at a defined level. Since the comparator (CMP) generates the comparison signal Vcmp by comparing the feedback signal Vc with the sensing signal Vs, the comparison signal Vcmp can be maintained at the high level for a time interval during which the level of the feedback signal Vc is lower than that of the sensing signal Vs. However, when the level of the feedback signal Vc is low, it indicates that the current required by the internal circuit 200 is small, that is, it indicates a low load interval in which a load is small.

As noted above, the OR gate provides the reset signal RST in response to the comparison signal Vcmp. Since the PWM signal is maintained at the low level while the high-level reset signal RST is applied to flip-flop 130, the power converter may be in the PSM in which the PWM signal does not vary during the low load interval. Since the first and second switching signals PG and NG output from gate driver 140 will not vary in the PSM, the two switch transistors MP and MN will not perform a switching operation. Thus, the efficiency of the power converter is increased.

Thus, embodiments of the invention may be seen as providing a controller with a comparison unit generating a set signal, an inverted set signal, the current sensing signal, and the feedback signal. The comparison unit further generates the ramp signal having a ramp waveform in response to the set signal and a reset signal, the sensing signal by adding the ramp signal to the current sensing signal, and the comparison signal by comparing the feedback signal with the sensing signal.

As the over-current protector and the zero current detector of FIG. 1 form a type of protection circuit for the power converter, they may be omitted in certain embodiments of the invention.

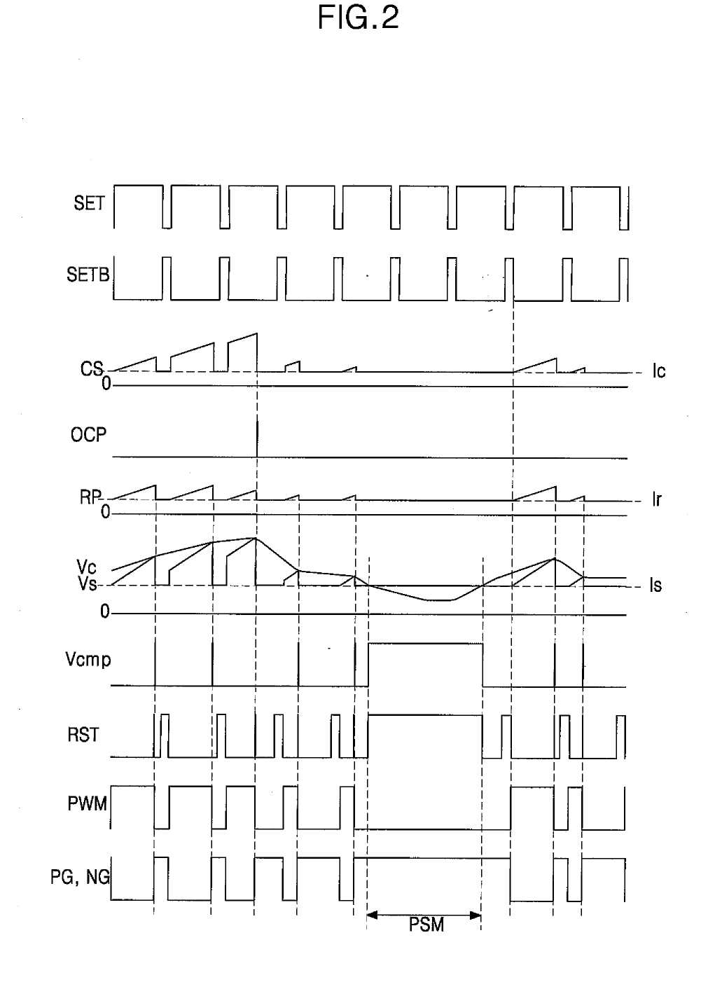

FIG. 2 is a related timing diagram illustrating the operation of the power converter of FIG. 1.

Thus, the power converter and its operation will be further described in relation to FIGS. 1 and 2 in the context of an example embodiment of the invention. The set signal SET and the inverted set signal SETB are output with complementary phases and with a period and a duty cycle defined by oscillator 160. The set signal SET is output to flip-flop 130 and ramp wave generator 150 and designates the operating speed of the power converter. The inverted set signal SETB is output to the OR gate and is used to generate at least one reset signal RST within a period during which the power converter operates, in response to the set signal SET. As shown in FIG. 1, the reset signal RST is output in response to the over-current sensing pulse OCP, the comparison signal Vcmp, and the inverted set signal SETB. However, the over-current sensing pulse OCP and the comparison signal Vcmp may not periodically output. In such cases, the inverted set signal SETB may be used to periodically generate the reset signal RST for stable operation of the power converter.

In response to the rising edge of the set signal SET, flip-flop 130 provides the high-level PWM signal. In response to the PWM signal, gate driver 140 provides the low-level first and second switching signals PG and NG that respectively control the PMOS transistor MP and the NMOS transistor MN. The PMOS transistor MP is turned ON in response to the low-level first switching signal PG and the NMOS transistor MN is turned OFF in response to the low-level second switching signal NG. When the PMOS transistor MP is turned ON and the NMOS transistor MN is turned OFF, the power supply voltage Vbat is applied to the first node nd1, the inductor L1 may output the output voltage Vo to the output node ndo in response to a current flowing through the first node nd1, and the first capacitor C1 smoothes the output voltage Vo. Flip-flop 130 provides the low-level PWM signal in response to the rising edge of the reset signal RST, and gate driver 140 provides the high-level first and second switching signals PG and NG in response to the low-level PWM signal. The PMOS transistor MP is turned OFF in response to the high-level first switching signal PG and may interrupt the power supply voltage Vbat applied to the first node nd1. The NMOS transistor MN is turned ON in response to the high-level second switch control signal NG, such that the electrical charge accumulated on the inductor L1 is transferred to the first capacitor C1.

Current sensor 110 provides the current sensing signal CS by sensing a current flowing to the first node nd1. Since the first node nd1 is connected to the output node ndo through the inductor L1 while the PMOS transistor MP is turned ON, current sensor 110 outputs the current sensing signal CS by sensing a current flowing to the PMOS transistor MP. Accordingly, whenever the PMOS transistor MP is turned ON, the current sensing signal CS exhibits a ramp waveform signal whose level gradually rises from the level corresponding to a current flowing to the output node ndo. As shown in FIG. 2, the current sensing signal CS may be constantly maintained at a regular level “Ic” for comparison with the feedback signal Vc.

Over-current protector 120 may receive the current sensing signal CS. When the current sensing signal CS rises above a defined threshold level, the over-current sensing pulse OCP is generated to prevent an over-current from flowing to the output node ndo. Since the over-current sensing pulse OCP is applied to the OR gate, the OR gate outputs the reset signal RST when the over-current protector 120 generates the over-current sensing pulse OCP. When flip-flop 130 is synchronized with the rising edge of the reset signal RST, the PWM signal transitions to a low level and the first and second switching signals PN and NG transition to a high level. The PMOS transistor MP interrupts the current applied to the output node ndo in response to the first switching signal PG, thereby preventing the current from flowing to the output node ndo.

Ramp wave generator 150 provides the ramp signal RP having a ramp waveform in response to the set signal SET and may be reset in response to the reset signal RST. Like the current sensing signal CS, the ramp signal RP may be constantly maintained at a regular level “Ir” for comparison with the feedback signal Vc.

The sensing signal Vs may be provided by adding the current sensing signal CS output from current sensor 110 to the ramp signal RP from ramp wave generator 150 in the adder (SUM). The sensing signal Vs may thus have a level that is equal to or higher than a level “Is” corresponding to a sum of the predetermined level “Ic” designated for the current sensing signal CS and the predetermined level “Ir” designated for the ramp signal RP.

On the other hand, the voltage apparent at the second node nd2 and applied to error amplifier 180 may have a level obtained by dividing the output voltage Vo apparent at the output node ndo by the first and second resistors R1 and R2. Error amplifier 180 thus provides the feedback signal Vc by amplifying the difference between the reference voltage output received from the reference voltage generator 190 and the voltage apparent at the second node nd2 having the level obtained by dividing the output voltage Vo by the first and second resistors R1 and R2. In error amplifier 180, an amplification ratio of the amplifier (AMP) may be controlled by the sum of impedances of the second capacitor C2 and the fourth resistor R4 and a resistance value of the third resistor R3. Accordingly, the voltage level of the feedback signal Vc will vary in proportion to the voltage level of the output voltage Vo.

The comparator (CMP) outputs the comparison signal Vcmp by comparing the feedback signal Vc with the sensing signal Vs. As described above, the comparator (CMP) outputs the high-level comparison signal Vcmp when the voltage level of the feedback signal Vc is lower than that of the sensing signal Vs, and outputs the low-level comparison signal Vcmp when the voltage level of the feedback signal Vc is higher than that of the sensing signal Vs. That is, when the voltage level of the sensing signal Vs is higher than that of the feedback signal Vc, a larger current than is required by internal circuit 200 may be supplied from the power supply voltage Vbat. Accordingly, the comparator (CMP) outputs the comparison signal Vcmp to interrupt a current output to internal circuit 200. Since a current required by internal circuit 200 may be small and the voltage level of the sensing signal Vs may be higher than that of the feedback signal Vc in the low load interval in which a load of the power converter is maintained in a low state, the high-level comparison signal Vcmp may be output.

The power converter according to the illustrated embodiment of the invention is able to constantly maintain the current sensing signal CS and the ramp signal RP at predetermined levels in order to set the low load interval. Since the feedback signal Vc is proportional to the output voltage Vo, it indicates that internal circuit 200 requires more current, if the voltage level is not 0V when the feedback signal Vc is low. In FIG. 2, the sensing signal Vs is constantly maintained at least at a first predetermined level “Is”. Accordingly, when the current required by the internal circuit 200 is small, that is, the load is small, the power converter may set the low load interval in which the voltage level of the feedback signal Vc is lower than that of the sensing signal Vs.

When any one of the over-current sensing signal OCP, the inverted set signal SETB, and the comparison signal Vcmp is applied at the high level, the reset signal RST output from the OR gate is output at the high level in order to interrupt the current output to internal circuit 200. Accordingly, the reset signal RST is maintained at the high level in the low load interval.

The PWM signal output from flip-flop 130 transitions to a high level synchronously with the rising edge of the set signal SET and transitions to a low level synchronously with the rising edge of the reset signal RST. Since flip-flop 130 in the illustrated example is a RST-edge-triggered flip-flop, the PWM signal may be maintained at the low level regardless of the set signal SET in the low load interval in which the reset signal RST is maintained at the high level. That is, an operation may be performed in the PSM. In the PSM, gate driver 140 may continuously maintain the first and second switching signals PG and NG at the high level. Consequently, the PMOS transistor MP and the NMOS transistor MN may not perform the switching operation, thereby preventing unnecessary power consumption. Accordingly, the power converter according to the example embodiments may operate in the PSM in the low load interval, thereby increasing its efficiency.

An example has been described in which the sensing signal Vs has or exceeds a first predetermined level “Is” since the current sensing signal CS and the ramp signal R are maintained at or above corresponding second and third predetermined levels “Ic” and “Ir”, but only one of the current sensing signal CS or the ramp signal RP need be configured to have the first predetermined level “Is” for setting the low load interval. A controlled voltage generator providing a separate level control signal that is different from the current sensing signal CS and the ramp signal RP may be additionally provided. The first predetermined level “Is” for setting the low load interval may be applied to the sensing signal Vs by configuring reference voltage generator 190 to output a level control signal.

According to certain embodiments of the invention, a power converter having an auto conversion function for a PSM and a control method thereof can provide a PSM capable of preventing unnecessary switching operations and, thus, improving the efficiency of the power converter by automatically switching to the PSM even when a load is small.

While example embodiments of the invention have been disclosed herein, it should be understood that other variations may be possible. Such variations fall within the scope of subject invention as defined by the following claims.

What is claimed is:

1. A power converter comprising:
an output unit connected between a power supply voltage, a ground voltage, and an output node, and configured to apply the power supply voltage or ground voltage to a first node in response to first and second switching signals, and further configured to provide an output voltage to the output node by smoothing the voltage apparent at the first node; and
a controller comparing a sensing signal generated at a predetermined level indicating a low load state and in response to a ramp signal and a current sensing signal, wherein the current sensing signal corresponds to current flowing to the first node in accordance with the magnitude of a load connected to the output node as indicated by a feedback signal,
the controller being configured to operate in a normal mode to generate a pulse width modulation signal activating the first and second switching signals when a level of the feedback signal is higher than the predetermined level, and being further configured to operate in a pulse skip mode to generate the pulse width modulation signal deactivating the first and second switching signals when the load is small and the level of the feedback signal falls below the predetermined level.

2. The power converter of claim 1, wherein the controller comprises:
a comparison unit configured to generate a set signal, an inverted set signal, the current sensing signal, and the feedback signal, further configured to generate the ramp signal of a ramp waveform in response to the set signal and a reset signal, further configured to generate the sensing signal by adding the ramp signal to the current sensing signal, and further configured to generate a comparison signal by comparing the feedback signal with the sensing signal; and
a driver configured to generate the reset signal in response to the inverted set signal and the comparison signal, further configured to generate the pulse width modulation signal having logic level transitions synchronous with a rising edge of the set signal and the reset signal in the normal mode and not having logic level transitions in the pulse skip mode in which the reset signal is maintained in a high-level state, and further configured to output the first and second switching signals in response to the pulse width modulation signal.

3. The power converter of claim 2, wherein the output unit comprises:
a first switch transistor connected between the power supply voltage and the first node and configured to receive the first switching signal;
a second switch transistor connected between the first node and the ground voltage and configured to receive the second switching signal;
an inductor connected between the first node and the output node and configured to accumulate or discharge charge in relation to a current flowing from the first node to the output node; and
a first capacitor connected between the output node and the ground voltage and configured to charge or discharge the output voltage applied to the output node.

4. The power converter of claim 3, wherein the comparison unit comprises:
an oscillator generating the set signal having a designated period and duty cycle and the inverted set signal having a phase complementary to the phase of the set signal;
a ramp wave generator generating in the normal mode the ramp signal having a level that increases in response to the rising edge of the set signal and transitioning back to an initial level in response to the reset signal, and generating in the pulse skip mode the ramp signal having a constant level in response to the reset signal being maintained at the high level;
a current sensor sensing current flow to the first node and providing the current sensing signal having a level that varies with the current flow;
an adder generating the sensing signal by adding the ramp signal to the current sensing signal;
an error amplifier providing the feedback signal by voltage dividing the output voltage, applying the divided voltage to a second node, and amplifying a voltage difference between the voltage of the second node and a reference voltage; and
a comparator providing the comparison signal by comparing the feedback signal with the sensing signal.

5. The power converter of claim 4, wherein the ramp signal equals or exceeds the predetermined level.

6. The power converter of claim 4, wherein the current sensing signal equals or exceeds the predetermined level.

7. The power converter of claim 4, wherein the sum of the ramp signal and the current sensing signal equal or exceeds the predetermined level.

8. The power converter of claim 4, wherein the comparison unit further comprises:
a control signal generator generating a control signal at the predetermined level in order to generate the sensing signal.

9. The power converter of claim 8, wherein the adder generates the sensing signal by adding the control signal, the ramp signal, and the current sensing signal.

10. The power converter of claim 4, wherein the driver comprises:
an OR gate providing the reset signal after performing an OR operation on the inverted set signal and the comparison signal;
a flip-flop providing the pulse width modulation signal of a first level synchronously with the rising edge of the set signal, the pulse width modulation signal of a second level synchronously with the rising edge of the reset signal, and a non-varying pulse width modulation signal in the pulse skip mode; and
a gate driver providing the first switching signal to turn ON the first switch transistor in response to the pulse width modulation signal of the first level and turn OFF the first switch transistor in response to the pulse width modulation signal of the second level, and provide the second switching signal to turn ON the second switch transistor in response to the pulse width modulation signal of the first level and turn OFF the second switch transistor in response to the pulse width modulation signal of the second level.

11. A control method for a power converter having an output unit connected between a power supply voltage, a ground voltage, and an output node, and configured to apply the power supply voltage or ground voltage to a first node in response to first and second switching signals and output an output voltage to the output node by smoothing a voltage level variation of the first node, the method comprising:
generating a ramp signal and a current sensing signal corresponding to a current flowing from the power supply voltage to the first node, and generating a sensing signal having or exceeding a control level for setting a low load state in response to the ramp signal and the current sensing signal;
generating a feedback signal having a voltage level corresponding to a load of an internal circuit connected to the output node;
operating in a normal mode to generate a pulse width modulation signal for activating the first and second switching signals by comparing the feedback signal with the sensing signal when a level of the feedback signal is higher than the control level, and automatically switching to a pulse skip mode by generating the pulse width modulation signal for deactivating the first and second switching signals when the load is small and the level of the feedback signal is lower than the control level; and
generating the first and second switching signals for controlling first and second switch transistors in response to the pulse width modulation signal.

12. The control method of claim 11, wherein generating the sensing signal includes:
generating the current sensing signal corresponding to the amount of current flowing from the power supply voltage to the first node;
generating the set signal having a designated period and duty rate and the inverted set signal having a phase opposite to that of the set signal;
generating the ramp signal of a ramp waveform in response to the set signal and a reset signal; and
generating the sensing signal by adding the ramp signal to the current sensing signal.

13. The control method of claim 12, wherein automatically switching includes:
generating a comparison signal by comparing the feedback signal with the sensing signal, and generating the reset signal by performing an OR operation on the inverted set signal and the comparison signal; and
generating the pulse width modulation signal whose level transitions to a first level in response to a rising edge of the set signal in the normal mode, transitions to a second level in response to a rising edge of the reset signal, and does not transition in response to a high-level reset signal in the pulse skip mode.

14. The control method of claim 13, wherein generating the first and second switching signals includes:
generating the first switching signal to turn on the first switch transistor in response to the pulse width modulation signal of the first level and to turn off the first switch transistor in response to the pulse width modulation signal of the second level; and
generating the second switching signal to turn on the second switch transistor in response to the pulse width modulation signal of the first level and to turn off the second switch transistor in response to the pulse width modulation signal of the second level.

15. The control method of claim 14, wherein the ramp signal has or exceeds the control level.

16. The control method of claim 14, wherein the current sensing signal has or exceeds the control level.

17. The control method of claim 14, wherein generating the sensing signal includes:
generating a control signal having the control level; and
generating the sensing signal by adding the current sensing signal, the ramp signal, and the control signal.
